(19) United States
(12) Patent Application Publication
(10) Pub. No.: US 2025/0372661 A1
(43) Pub. Date: Dec. 4, 2025

(54) COMPOSITE STRUCTURES HAVING A PRIMER LAYER AND METHODS OF MANUFACTURING THE COMPOSITE STRUCTURES

(71) Applicant: HONEYWELL INTERNATIONAL INC., Charlotte, NC (US)

(72) Inventors: Guangyan Wang, Shanghai (CN); Xin Wang, Shanghai (CN); Rakesh Vig, Durham, CT (US); Venugopal Arunajatesan, Denville, NJ (US)

(73) Assignee: HONEYWELL INTERNATIONAL INC., Charlotte, NC (US)

(21) Appl. No.: 19/175,095

(22) Filed: Apr. 10, 2025

Related U.S. Application Data
(60) Provisional application No. 63/652,941, filed on May 29, 2024.

(51) Int. Cl. H01M 4/66; H01M 4/04

(52) U.S. Cl. CPC H01M 4/667; H01M 4/0404

(57) ABSTRACT

Composite structures and methods of manufacturing the composite structures are provided herein. The composite structures comprise a metal layer comprising an elemental metal and/or a metal alloy, a primer layer bonded to the metal layer, and an additional layer bonded to the primer layer on an opposite side of the primer layer from the metal layer. The primer layer comprises a first vinyl copolymer formed from vinyl monomers having an acid function or derivative thereof and a different second vinyl copolymer formed from the same vinyl monomers as the first vinyl copolymer. In embodiments, the composite structures are battery components. In embodiments, the composite structures are manufactured by forming a dry mixture comprising an active material and a binder, forming a primer layer on a metal layer, and adhering the dry mixture to the metal layer with the primer layer in the absence of a drying step.

### CROSS REFERENCE TO RELATED APPLICATION

This application claims the benefit of U.S. Provisional Application No. 63/652,941 filed May 29, 2024.

### TECHNICAL FIELD

The present disclosure generally relates to composite structures, and more particularly relates to composite structures including a primer layer in the composite structures.

### BACKGROUND

In various manufacturing processes, a need exists for a primer layer that is capable of bonding to one or more surfaces in a composite structure. Such a primer layer may be formed in the manufacturing of composite structures including multilayer metal objects, packaging materials, and polymer films. For example, the primer layer may be formed in the manufacturing of articles such as batteries and capacitors. In some applications, a primer layer is needed that can bond to a metal surface and serve as a tie layer and/or passivation layer between the metal surface and another surface or material.

Existing composite structures having primer layers are subject to various considerations depending on the particular application, and many composite structures have known shortcomings related to their primer layers. Some primer layers do not have strong enough adhesion properties to maintain a bond between materials. This insufficient adhesion may be due to, for example, an insufficient affinity between the primer layer and the materials being adhered. Insufficient adhesion can cause the composite structure to fall apart or malfunction.

Further, in some applications, solvent resistance is an important consideration. Many existing composite structures have primer layers which do not have sufficient solvent resistance to remain intact and may dissolve upon contact with certain solvents. Dissolution of the primer layer compromises the adhesion and protection provided by the primer layer to underlying layers. In some applications, the primer layer may function as a barrier to protect underlying layers in the composite structure, and dissolution of the primer layer may compromise the barrier function of the primer layer. In some instances, compromise of the barrier function of the primer layer may result in incompatible materials coming in contact with each other, which can lead to the formation of unwanted byproducts and other undesirable effects. For example, metals are vulnerable to corrosion when exposed to certain organic solvents and/or fluorinated materials. If a primer layer is formed on a metal surface in a composite structure, and the primer layer dissolves upon contact with a solvent, the solvent and any fluorinated materials present along with the solvent may then contact the metal surface and cause corrosion and possible generation of unwanted reaction products.

As one specific example of a circumstance in which dissolution of a primer layer in a composite structure might be a concern, in electrodes within lithium ion batteries, a primer layer generally adheres a metal layer (e.g. a current collector) comprising an elemental metal and/or a metal alloy to an active layer (e.g. lithium oxide). Lithium-ion batteries generally contain electrolyte that includes fluorinated compounds dissolved in battery solvents, with the electrolyte generally maintained in an area adjacent to the active layer and opposite to the current collector that underlies the primer layer. If the primer layer does not exhibit sufficient solvent resistance to the battery solvent, then the fluorinated compounds may penetrate the primer layer and contact the current collector. Depending on the material of the current collector, the fluorinated compounds in the battery solvent and metal atoms in the current collector may react to form unwanted byproducts such as hydrofluoric acid.

In a lithium-ion battery manufacturing process, electrodes are generally produced using a wet process wherein an active material is made into a slurry and coated onto a current collector. Such wet processes require large amounts of primer solvents such as N-methylpyrrolidone (NMP) to create the slurry. Use of large amounts of primer solvents is undesirable because the primer solvent must often be recovered, purified, and reused, which is expensive, requires specialized machinery, and consumes a large amount of energy. To combat these problems, various dry manufacturing processes are being developed wherein a minimal amount of primer solvent is used such that a drying step is not required. Dry electrode processes entail production of a dry film of active material which is laminated to the current collector using a primer layer while minimizing the use of a solvent. However, with the use of minimal amounts of primer solvent, it is often challenging to properly adhere layers of the composite structure to each other. Primer layers are used for adhesion purposes in some dry manufacturing processes, but existing primer layers often do not have sufficient adhesive properties and solvent resistance to battery solvent to yield optimal composite structures.

Accordingly, it is desirable to provide composite structures with primer layers having excellent adhesive properties in combination with maximized solvent resistance, particularly with excellent solvent resistance against typical solvents used in battery applications. In addition, it is desirable to provide composite structures with primer layers that can be effective, in terms of adhesion and solvent resistance, even when applied using dry manufacturing processes. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Composite structures and methods of manufacturing the composite structures are provided herein. The composite structures comprise a metal layer comprising an elemental metal and/or a metal alloy, a primer layer bonded to the metal layer, and an additional layer bonded to the primer layer on an opposite side of the primer layer from the metal layer. The primer layer comprises a first vinyl copolymer and a second vinyl copolymer. The first vinyl copolymer is formed from vinyl monomers having an acid function or derivative thereof. The second vinyl copolymer is different from the first vinyl copolymer, but the second vinyl copolymer is formed from the same vinyl monomers as the first vinyl copolymer.

In embodiments, the composite structures are battery components. The battery components provided herein comprise a current collector; a primer layer bonded to the current collector; an active layer comprising an active material and a binder, bonded to the primer layer on an opposite side of the primer layer from the current collector; and a battery solvent proximate to the active layer. The primer layer comprises a first vinyl copolymer and a second vinyl copolymer. The first vinyl copolymer is formed from vinyl monomers having an acid function or derivative thereof. The second vinyl copolymer is different from the first vinyl copolymer, but the second vinyl copolymer is formed from the same vinyl monomers as the first vinyl copolymer.

The methods of manufacturing the composite structures comprise the steps of forming a dry mixture comprising an active material and a binder, forming a primer layer on a metal layer comprising an elemental metal and/or a metal alloy, and adhering the dry mixture to the metal layer with the primer layer. The composite structures are manufactured in the absence of a drying step. The primer layer formed on the metal layer comprises a first vinyl copolymer and a second vinyl copolymer. The first vinyl copolymer is formed from vinyl monomers having an acid function or derivative thereof. The second vinyl copolymer is different from the first vinyl copolymer, but the second vinyl copolymer is formed from the same vinyl monomers as the first vinyl copolymer.

### BRIEF DESCRIPTION OF THE DRAWINGS

The present disclosure will hereinafter be described in conjunction with the following drawing figures, wherein like numerals denote like elements, and wherein:

FIG. 1 shows a cross section of a composite structure in accordance with this disclosure having a metal layer, a primer layer, and an additional layer.

FIG. 2 shows a cross section of an exemplary battery structure comprising an embodiment of an electrode in accordance with this disclosure.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Composite structures are provided herein including layers adhered together with a primer layer having excellent adhesion properties in combination with maximized solvent resistance. It has been found that the primer layers described within the composite structures provided herein are capable of adhering to metal surfaces and attaching other materials to the metal surfaces with excellent adhesion. Specifically, it has been found that primer layers containing two different vinyl copolymers which are formed from the same vinyl monomers have improved adhesion properties as compared to existing primer layers, which may contain only one copolymer. The maximized adhesion properties of the primer layers described herein ensure a strong, lasting bond between materials. It has also been found that the primer layers as provided herein are resistant to various solvents, particularly solvents that are typically used in battery applications. This solvent resistance allows the primer layers to maintain their function as an adhesive and barrier layer when the primer layers come into contact with solvents in various environments, preventing problems such as corrosion of the underlying metal surface in a composite structure.

In embodiments, the primer layer in the composite structure is formed by providing an emulsion containing the two different vinyl copolymers which are formed from the same vinyl monomers, and coating the emulsion onto the metal surface in the absence of a non-aqueous solvent to form a substantially non-crosslinked layer of the copolymers. It has been found that forming the primer layer in the composite structure through the recited method contributes to maximized adhesion and solvent resistance. It has also been found that the emulsions used to form the primer layer in some embodiments exhibit excellent polymer rheology properties, including maximized storage modulus and loss modulus values, which leads to excellent performance of the primer layer.

Additionally, it has been found that the composite structures provided herein have primer layers that exhibit excellent temperature resistance and anti-corrosion properties in addition to the ability to withstand higher voltages than existing primer layers. Further, it has been found that materials such as conductive additives can be incorporated into the primer layers, providing the primer layers with properties such as electrical conductivity.

In embodiments, these excellent properties make the primer layers suitable for use in battery applications. Specifically, the battery components as provided herein provide for the use of a primer layer in the battery component wherein the primer layer has maximized adhesion properties and can withstand the conditions of the battery environment. The primer layers containing two different vinyl copolymers which are formed from the same vinyl monomers have been found to be effective adhesives and passivators in battery components, including battery components manufactured through dry electrode processes. The methods as provided herein provide for the formation of a primer layer in a composite structure in which at least one of the layers is formed through a dry manufacturing process, while achieving sufficient adhesion and solvent resistance in the absence of a drying step.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

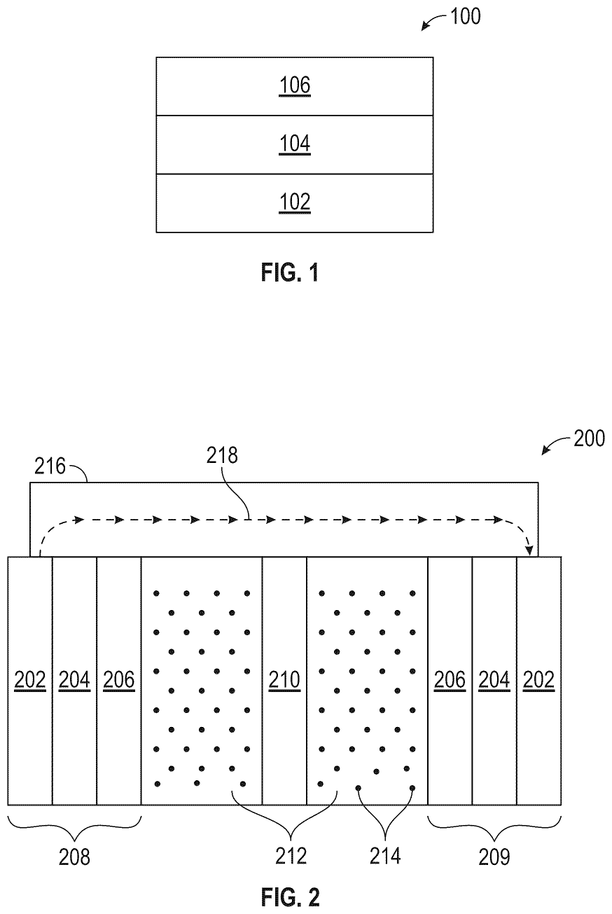

As illustrated in FIG. 1, the composite structures 100 provided herein include a metal layer 102, a primer layer 104, and an additional layer 106. As used herein, a “metal layer” is defined as a layer comprising an elemental metal and/or a metal alloy and having an electrical conductivity of at least 1.0×10⁶ S/m at a temperature of 20° C. For example, the metal layer 102 may comprise an elemental metal such as aluminum, copper, titanium, cobalt, iron, nickel, zinc and/or combinations thereof. Alternatively and/or additionally, the metal layer 102 may comprise an alloy such as steel, brass, bronze, and/or combinations thereof.

The composite structures provided herein further include a primer layer 104 bonded to the metal layer 102. In embodiments, the primer layer 104 is bonded directly to the metal layer 102. As used herein, a layer being bonded “directly” to another layer means that there are no intervening layers between the layers. The primer layer 104 comprises a first vinyl copolymer and a second vinyl copolymer. As used herein, “vinyl copolymer” refers to a polymer formed from at least two different vinyl monomers. “Vinyl monomer(s)” refers to monomer(s) which have (H2C═C—) group in their structure. The first vinyl copolymer in the primer layer 104 is formed from vinyl monomers having an acid function or derivative thereof. For example, the first vinyl copolymer may be formed from acrylic acid, vinyl acetate, maleic acid, methacrylic acid, and/or combinations thereof. In addition to at least one vinyl monomer having an acid function or derivative thereof, the first vinyl copolymer may be formed from vinyl monomers that do not have an acid function or derivative thereof. For example, the first vinyl copolymer may be formed from hydrocarbon monomers such as ethylene or propylene. In embodiments, the first vinyl copolymer may be ethylene acrylic acid copolymer, ethylene methacrylic acid copolymer, ethylene-vinyl acetate copolymer, or maleated polyolefin.

The second vinyl copolymer in the primer layer 104 is formed from the same vinyl monomers as the first vinyl copolymer, but the second vinyl copolymer is different from the first vinyl copolymer in one or more other ways. In embodiments, the second vinyl copolymer differs from the first vinyl copolymer by having a different configuration of monomer-derived units. For example, in embodiments, the first vinyl copolymer is a block copolymer, and the second vinyl copolymer is a random copolymer. The first vinyl copolymer and the second vinyl copolymer may also differ in overall structure. For example, in an embodiment, the first vinyl copolymer is a linear copolymer, and the second vinyl copolymer is a branched copolymer. Further, in embodiments, the second vinyl copolymer differs from the first vinyl copolymer by having a different ratio of monomer derived units. For example, if the first vinyl copolymer and the second vinyl copolymer are ethylene-acrylic acid copolymers, then the second vinyl copolymer is formed with a different ratio of ethylene monomers to acrylic acid monomers than the first vinyl copolymer.

A melt flow index represents the ease of flow of a melted polymer. In embodiments, the first vinyl copolymer may have a melt flow index (MFI) of greater than 1 g/10 min, alternatively from about 1 g/10 min to about 500 g/10 min, alternatively from about 20 g/10 min to about 500 g/10 min, alternatively from about 500 g/10 min to about 1300 g/10 min, alternatively greater than 1300 g/10 min, as measured in accordance with ASTM D-1238 at a copolymer temperature of 190° C. and with a load of 2.16 kg. In embodiments, the first vinyl copolymer may have a melt flow index (MFI) of from about 1 g/10 min to about 500 g/10 min, as measured in accordance with ASTM D-1238 at a copolymer temperature of 190° C. and with a load of 21.6 kg. In embodiments, the second vinyl copolymer may have a melt flow index (MFI) of greater than 1 g/10 min, alternatively from about 1 g/10 min to about 500 g/10 min, alternatively from about 20 g/10 min to about 500 g/10 min, alternatively from about 500 g/10 min to about 1300 g/10 min, alternatively greater than 1300 g/10 min, as measured in accordance with ASTM D-1238 at a copolymer temperature of 190° C. and with a load of 2.16 kg. In embodiments, the first vinyl copolymer may have a melt flow index (MFI) of from about 1 g/10 min to about 500 g/10 min, as measured in accordance with ASTM D-1238 at a copolymer temperature of 190° C. and with a load of 21.6 kg. In embodiments, a composition containing the first vinyl copolymer and the second vinyl copolymer has a melt flow index of from about 1 g/10 min to about 5000 g/10 min, alternatively from about 1 g/10 min to about 1300 g/10 min, alternatively from about 1 g/10 min to about 1000 g/10 min, alternatively from about 1 g/10 min to about 600 g/10 min, alternatively from about 20 g/10 min to about 600 g/10 min, as measured in accordance with ASTM D-1238 at a copolymer temperature of 190° C. and with a load of 2.16 kg. In embodiments, the second vinyl copolymer differs from the first vinyl copolymer by having a difference in melt flow index of from about 1 g/10 min to about 3700 g/10 min, alternatively from about 1 g/10 min to about 1300 g/10 min, alternatively from about 1 g/10 min to about 300 g/10 min, alternatively from about 30 g/10 min to about 300 g/10 min, as measured in accordance with ASTM D-1238 at a copolymer temperature of 190° C. and with a load of 2.16 kg. In embodiments, the second vinyl copolymer differs from the first vinyl copolymer by having a difference in melt flow index of from about 1 g/10 min to about 3700 g/10 min, alternatively from about 1 g/10 min to about 1500 g/10 min, alternatively from about 1 g/10 min to about 500 g/10 min, alternatively from about 20 g/10 min to about 500 g/10 min, as measured in accordance with ASTM D-1238 at a copolymer temperature of 190° C. and with a load of 21.6 kg. It has been found that a primer layer 104 having at least two vinyl copolymers formed from the same monomers having an acid function or derivative thereof, but having the recited difference in melt flow index, has excellent solvent resistance properties in addition to excellent adhesion properties. Specifically, it has been found that the recited difference in melt flow index leads to a primer layer 104 which is resistant to the below-described solvents, requiring excessive mechanical action to delaminate the primer layer 104 from the metal layer 102 after exposure to the solvents.

The melt flow index of each vinyl copolymer is correlated with the weight average molecular weight of the vinyl copolymer. Specifically, the higher the weight average molecular weight, the lower the melt flow index. In embodiments, the second vinyl copolymer differs from the first vinyl copolymer by having a difference in weight average molecular weight of at least 2,000 Daltons, alternatively at least 6,000 Daltons. In embodiments, the first vinyl copolymer has a weight average molecular weight of from about 100 Daltons to about 3,000 Daltons, and the second vinyl copolymer has a weight average molecular weight of from about 20,000 Daltons to about 200,000 Daltons, alternatively from about 50,000 Daltons to about 100,000 Daltons.

In embodiments, the weight ratio of the first vinyl copolymer to the second vinyl copolymer is from about 4:1 to about 1:4, alternatively from about 2:1 to about 1:2, alternatively from about 1:1 to about 1:3. It has been found that the recited ranges lead to maximized adhesion of the primer layer without causing problems with processability of the material that is applied to form the primer layer. In embodiments, the first vinyl copolymer and the second vinyl copolymer make up at least about 20 wt %, alternatively from about 20 wt % to less than 90 wt %, alternatively from about 40 wt % to about 90 wt % of the primer layer, based on a total weight of the primer layer.

In embodiments, the primer layer may additionally include a vinyl copolymer formed from different vinyl monomers than the first vinyl copolymer and the second vinyl copolymer. The additional vinyl copolymer may be formed from vinyl monomers having an acid function or derivative thereof, or the additional vinyl copolymer may be formed from vinyl monomers that do not have an acid function or derivative thereof. In embodiments, the primer layer may additionally include a bactericide.

In embodiments, the first vinyl copolymer and the second vinyl copolymer are in a continuous phase, and the primer layer 104 further comprises a discontinuous phase. As used herein, “continuous phase” refers to a matrix or base phase having a continuous character. As used herein, “discontinuous phase” refers to material which is separate from the continuous phase and which is embedded or dispersed within the continuous phase in a discontinuous form. The discontinuous phase may include, for example, conductive additives, dielectric additives, insulating additives, colorants, reinforcing agents, and/or combinations thereof. In embodiments, the discontinuous phase is electrically conductive (i.e. has a conductivity of at least 1.0×10⁻² S/m). For example, the discontinuous phase may comprise a conductive additive such as carbon black, conductive graphite, carbon fiber, carbon nanotubes, activated carbon, graphene, and/or combinations thereof. In embodiments in which the discontinuous phase is electrically conductive, the primer layer 104 may also be electrically conductive (i.e. has a conductivity of at least 1.0×10⁻² S/m). Electrical conductivity of the primer layer 104 enables the primer layer 104 to be used in applications requiring electrical conductivity, such as battery components and/or integrated circuit components.

In embodiments, the primer layer 104 has a thickness of from about 0.1 microns to about 5.0 microns, alternatively from about 0.3 microns to about 3 microns, alternatively from about 0.5 microns to about 2.0 microns. Thicknesses in the recited ranges enable the primer layer to provide enough protection to the metal layer without creating an excessive obstruction between the layers of the composite structure or using an excessive amount of material. In embodiments, the primer layer 104 is substantially free of products of a crosslinking agent. In embodiments, the first vinyl copolymer and the second vinyl copolymer are substantially free of crosslinks. In embodiments, the primer layer 104 is not thermoset.

In embodiments, the primer layer 104 exhibits excellent resistance to cyclic amide-containing solvents. For example, the primer layer 104 may exhibit resistance to alkyl pyrrolidone solvents such as N-methyl-2-pyrrolidone (NMP) and/or N-ethyl-2-pyrrolidone (NEP). The recited solvents are commonly used in wet manufacturing processes for composite articles 100, such as electrodes of lithium ion batteries, so it is important for the primer layer 104 to be resistant to these solvents. Otherwise, the primer layer 104 may break down during a wet manufacturing process, leading to a composite article 100 with a compromised primer layer 104. In embodiments, the primer layer 104 exhibits resistance to solvents commonly used in batteries, e.g. within electrolyte in the batteries. For example, the primer layer 104 may exhibit resistance to carbonate solvents, such as ethylene carbonate, dimethyl carbonate, propylene carbonate, diethyl carbonate, or ethyl methyl carbonate. The primer layer 104 may also exhibit resistance to methyl acetate, methyl propionate, dimethyl ether, and/or tetrahydrofuran. As another example, the primer layer 104 may exhibit resistance to solvents mixed with electrolytes such as LiPF₆ (lithium hexafluorophosphate), LiBF₄ (lithium tetrafluoroborate), or LiClO₄ (lithium perchlorate). As described below in more detail, embodiments of the composite structures 100 may be electrodes of a battery. Accordingly, the primer layer 104 may advantageously resist solvents used in batteries so that the primer layer does not break down upon exposure to solvents within the battery. The primer layer 104 may also exhibit resistance to water and aqueous solutions. In one particular embodiment, the primer layer 104 exhibits an acceptable resistance to solvent intrusion and polymer breakdown in accordance with a tape test for adhesion conducted in accordance with ASTM D3359-17.

The composite structures 100 provided herein further include an additional layer 106 bonded to the primer layer 104 on an opposite side of the primer layer 104 from the metal layer 102. In embodiments, the additional layer 106 may be another metal layer 102, a plastic layer, a concrete layer, a woven fiber layer, a wood layer, and/or combinations thereof. In embodiments, the additional layer 106 is bonded directly to the primer layer 104.

In embodiments, the composite structure may be a component that can be used in an integrated circuit, such as a transistor, a resistor, a capacitor, or a diode. In embodiments, the composite structure is a battery component (i.e. an electrode of a battery). The battery component may be incorporated into a larger battery structure. The battery structure may be a battery cell such as a pouch cell, a cylindrical cell, or a prismatic cell. In one particular embodiment, as illustrated in FIG. 2, the composite structure is an electrode 208, 209 (i.e. an anode 208 or a cathode 209) contained within a battery structure 200. The battery structure 200 illustrated in FIG. 2 is a lithium-ion pouch cell.

The battery structure 200 illustrated in FIG. 2 comprises two electrodes 208, 209 (an anode and a cathode). The anode 208 is the negative electrode, and the cathode 209 is the positive electrode. Electrons 218 flow from the anode 208 to the cathode 209 through a connecting wire 216. In embodiments, the connecting wire 216 comprises an elemental metal or metal alloy having an electrical conductivity of at least 1.0×10⁶ S/m at a temperature of 20° C. The anode 208 and the cathode 209 are separated from each other by a separator 210. The separator 210 may be made of a polymer such as polyethylene, polypropylene, polyvinyl chloride, and/or combinations thereof. Alternatively, the separator 210 may be made of, for example, a ceramic material, a nonwoven fiber (e.g. nylon or polyester), rubber, and/or combinations thereof. In embodiments, the separator 210 may be a composite structure that does not contain a metal layer. Between the separator 210 and each electrode 208, 209 is the battery solvent 212, as described above. The battery solvent may comprise an electrolyte 214 dissolved in the battery solvent 212. In embodiments, the electrolyte may be a fluorinated compound. For example, in a lithium-ion battery, the electrolyte may be a lithium salt such as LiPF₆ (lithium hexafluorophosphate), LiBF₄ (lithium tetrafluoroborate), LiClO₄ (lithium perchlorate), and/or combinations thereof. In embodiments, the battery solvent 212 may be in direct contact with the primer layer 204, for example if the battery solvent 212 permeates the active layer 206.

In embodiments in which the composite structure 100 is an electrode 208, 209, the metal layer 102 is a current collector 202. The electrode 208, 209 comprises the current collector 202 on a side of the respective electrodes 208, 209 opposite the battery solvent 212. In an embodiment, the electrode is an anode 208, and the metal layer 102 is a current collector 202 comprising copper. In another embodiment, the electrode is a cathode 209, and the metal layer 102 is a current collector 202 comprising aluminum. The electrodes 208, 209 comprise the primer layer 204 in accordance with this disclosure, as described above, bonded to the current collector 202. In embodiments, the electrode 208 further comprises an additional layer 106 (which, in the electrode embodiments, is an active layer 206 comprising an active material and a binder) bonded to the primer layer 204 on the side opposite the current collector 202. The active layer 206 is on the side of the respective electrodes 208, 209 nearest to the battery solvent 212. In embodiments, the active material in the active layer 206 is a metal oxide. For example, the active material may be a lithium oxide such as lithium cobalt oxide, lithium manganese oxide, lithium iron oxide, lithium nickel manganese cobalt oxide, and/or combinations thereof. In embodiments, the binder in the active layer 206 may be a fluoropolymer such as polyvinylidene fluoride (PVDF).

Methods of forming the composite structures and battery components are further provided herein. In embodiments, the composite structures are formed by coating the metal layer with a water-based emulsion comprising the first vinyl copolymer and the second vinyl copolymer, in the absence of a crosslinking agent. Application of the material which forms the primer layer in the form of an emulsion ensures that the copolymers are dispersed throughout the primer layer, ensures that any material present in the discontinuous phase is dispersed throughout the primer layer, and facilitates spreading so that the primer layer has a uniform thickness. Use of the emulsion to form the primer layer also contributes to processing advantages during dry manufacturing processes, as described below. Forming the primer layer in the absence of a crosslinking agent is significant because existing primer layers may not be able to exhibit sufficient adhesion and solvent resistance without the use of a crosslinking agent. The specific combination of copolymers in the primer layers provided herein allows for excellent performance, even when the primer layers are substantially free of crosslinking or thermosetting. In embodiments, the additional layer 106 (e.g. the active layer 206) is formed in the absence of a non-aqueous solvent, the benefits of which are described below.

It has been found that the polymer emulsion containing the at least two vinyl copolymers formed from the same monomers having an acid function or derivative thereof, but having the above-recited difference in melt flow index, has excellent polymer rheology properties. Specifically, the polymer emulsion has a maximized storage modulus and a maximized loss modulus, especially at temperatures above about 90° C. The maximized storage modulus contributes to elasticity of the material used to form the primer layer, and thus contributes to cohesion of the primer layer. The maximized loss modulus contributes to flowability of the material used to form the primer layer, leading to excellent wetting properties and maximized adhesion of the material to the metal layer.

In embodiments, the composite structures are formed by coating the metal layer with a composition formed from the water-based emulsion comprising the first vinyl copolymer and the second vinyl copolymer, a conductive additive, and optionally a dispersant, a defoamer, and/or a wetting agent. In embodiments, the conductive additive is selected from graphene, carbon nanotubes, carbon fibers, activated carbon, graphite, carbon black, or combinations thereof. In embodiments, the defoamer is selected from ethanol, silica, fatty acids, fatty alcohols, polydimethylsiloxanes, or combinations thereof. In embodiments, the wetting agent is selected from silicone-based wetting agents, polyethylene glycol, polyethylene glycol ether, sulfates, sulfonates, or combinations thereof. The weight ratio, on a dry basis, of the combined weight of the first vinyl copolymer and the second vinyl copolymer to the weight of the conductive additive may be from about 0.05:1 to about 1:1. The weight ratio, on a dry basis, of the dispersant to the conductive additive may be from about 0.01:1 to about 0.15:1. The weight ratio, on a dry basis, of the defoamer to the conductive additive may be from about 0.01:1 to about 0.15:1. The weight ratio, on a dry basis, of the wetting agent to the conductive additive may be from about 0.01:1 to about 0.15:1.

In embodiments, the composite structures are manufactured through a dry manufacturing method. As used herein, “dry manufacturing method” means that the composition used to from the active layer is substantially free of a non-aqueous solvent. Conducting the manufacturing method in the absence of a drying step is possible because minimal amounts of solvent are used. The methods include forming an active material and a binder into a dry mixture. Formation of the dry mixture may be accomplished using any known mixing method. In embodiments, the active material and the binder are mixed in powder form to form the dry mixture in powder form. In embodiments, the dry mixture further comprises an additive, such as a conductive agent. In embodiments, no solvent is used when forming the active layer. The methods further include forming a primer layer comprising a first vinyl copolymer and a second vinyl copolymer, in accordance with this disclosure as described above, on a metal layer. Then, the dry mixture is adhered to the metal layer with the primer layer. In embodiments, the adhering step comprises thermal lamination and/or calendering.

Dry manufacturing processes reduce the risk of corrosion or other damage that may be caused by solvents such as NMP, which are traditionally used in the manufacture of composite structures, and of electrodes in particular. Further, dry manufacturing processes generally consume less energy because the processes do not require the use of a large amount of heat or air flow in order to remove solvent. Any processing equipment needed for a drying step can also be omitted, leading to cost savings and increased processing efficiency. The particular blend of copolymers in the primer layers provided herein works especially well in dry manufacturing processes because it exhibits excellent adhesion and solvent resistance even when the active layer is formed through a dry process, whereas existing primer layer materials may exhibit insufficient performance when the active layer is formed through a dry process. Further, application of the primer layer material in the form of an emulsion may provide added benefits in the context of dry manufacturing processes because it improves the adhesion of the primer layer to both the metal layer and the dry mixture during and after the manufacturing process.

### EXAMPLES

### Example 1

Various oil-in-water emulsions of ethylene-acrylic acid (EAA) copolymers, as described in Table 1 below, were obtained. Copolymers A, B, and C are comparative examples not in accordance with this disclosure. The polymer rheology properties were analyzed as described below. Each oil-in-water emulsion was mixed with carbon black in an amount of 5 wt % dry on dry, based on a total dry weight of the mixture, and coated onto aluminum foil to form a primer layer with a thickness of 2 micrometers. The primer layer was allowed to cure at a temperature of 105° C. for 5 minutes. Several samples of composite structures were created through this method using each emulsion.

Then, some of the composite structures created using each emulsion were soaked in dimethyl carbonate solvent for two hours at a solvent temperature of 25° C. The solvent resistance of each sample was measured as described below. The remaining composite structures, which were not soaked in the solvent, were analyzed for adhesion properties as described below. The results are shown in Table 2.

TABLE 1
Composition of Emulsions Used to Form Primer Layers

| | Emulsion | | | Polymer | |
|---|---|---|---|---|---|
| | Solid | Chemistry | | AA | |
| Copolymer | Content | of | MFI of | Content | Other |
| Emulsion | (%) | Copolymers | Composition | (%) | Components |
| Comparative | 45 | EAA | >5000 | 15 | DMEA, |
| Example A | | | | | ammonia, |
| | | | | | bactericide |
| Comparative | 45 | EAA | >5000 | 15 | Ammonia, |
| Example B | | | | | bactericide |
| Comparative | 45 | EAA | >5000 | 13 | Ammonia, |
| Example C | | | | | bactericide |
| D | 40 | EAA | >1300 | 15 | Ammonia, |
| | | | | | bactericide |
| E | 35 | EAA | 890 | 15 | Ammonia, |
| | | | | | bactericide |
| F | 30 | EAA | 280 | 15 | Ammonia, |
| | | | | | bactericide |

TABLE 2
Performance of Different Oil-In-
Water Emulsions of EAA Copolymers

| | | Polymer | |
|---|---|---|---|
| Emulsion | Solvent Resistance | Rheology | Adhesion |
| Comparative Example | 1 | 1 | 4 |
| A | | | |
| Comparative Example | 1 | 1 | 4 |
| B | | | |
| Comparative Example | 1 | 1 | 4 |
| C | | | |
| D | 2 | 2 | 4 |
| E | 2 | 3 | 4 |
| F | 4 | 4 | 4 |

To rate the polymer rheology, the modulus (both the storage modulus G′ and the loss modulus G″) of the emulsions used to form the primer layer was measured using a TA Instruments Rheolyst AR 2000ex rotating rheometer at a temperature of 90° C. The polymer rheology for the emulsions used to form the primer layer in the composite articles was rated qualitatively on a scale of 1 to 4. A rating of 4 represents excellent rheology for this application (i.e. highest G′ and G″ values). A rating of 1 represents poor rheology for this application (i.e. lowest G′ and G″ values).

To rate the solvent resistance, after the two hour soaking period, the composite structures were removed from the solvent, and a tape test for adhesion was conducted in accordance with ASTM D3359-17. The solvent resistance for the composite articles created using each emulsion was rated qualitatively on a scale from 1 to 4. A rating of 4 represents the lowest removal area of the primer layer using the tape (i.e. excellent solvent resistance). A rating of 1 represents the highest removal area of the primer layer using the tape (i.e. poor solvent resistance). A rating of 3 represents a solvent resistance that is acceptable but not excellent. A rating of 2 represents a solvent resistance that is not acceptable but not as poor as a 1.

To rate the adhesion, the tape stripping test method described above was used. The tape was used to attempt to remove the primer layer from the aluminum foil (without first soaking the composite articles in any solvent). A rating of 4 represents the lowest removal area of the primer layer using the tape (i.e. excellent adhesion). A rating of 1 represents the highest removal area of the primer layer using the tape (i.e. poor adhesion). A rating of 3 represents an adhesion that is acceptable but not excellent. A rating of 2 represents an adhesion that is not acceptable but not as poor as a 1.

The results in Table 1 above show that a primer layer formed from an oil-in-water emulsion of a combination of two different EAA copolymers (emulsions D, E, and F) exhibited improved solvent resistance to dimethyl carbonate solvent as compared to a primer layer formed from an oil-in-water emulsion of a single EAA copolymer (emulsions A, B, and C). Further, the results in Table 1 show that an oil-in-water emulsion of EAA copolymers having an MFI of less than 5000 g/10 min shows improved polymer rheology properties over an oil-in-water emulsion having an MFI of greater than 5000 g/10 min. Solvent resistance of the primer layer was also improved when an oil-in-water emulsion of EAA copolymers having an MFI of less than 5000 g/10 min (and especially when an oil-in-water emulsion of EAA copolymers having an MFI of less than 1300 g/10 min) was used to form the primer layer.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed:

1. A composite structure comprising:
a metal layer comprising an elemental metal and/or a metal alloy;
a primer layer bonded to the metal layer, the primer layer comprising:
a first vinyl copolymer formed from vinyl monomers having an acid function or derivative thereof; and
a second vinyl copolymer different from the first vinyl copolymer, wherein the second vinyl copolymer is formed from the same vinyl monomers as the first vinyl copolymer; and
an additional layer bonded to the primer layer on an opposite side of the primer layer from the metal layer.

2. The composite structure of claim 1, wherein the primer layer is bonded directly to the metal layer.

3. The composite structure of claim 1, wherein the primer layer is formed by coating the metal layer with a water-based emulsion comprising the first vinyl copolymer and the second vinyl copolymer, in the absence of a crosslinking agent.

4. The composite structure of claim 3, wherein the primer layer is formed in the absence of a non-aqueous solvent.

5. The composite structure of claim 1, wherein the first vinyl copolymer and the second vinyl copolymer are formed from vinyl monomers having an acid function or derivative thereof selected from the group of acrylic acid, vinyl acetate, maleic acid, methacrylic acid, and combinations thereof.

6. The composite structure of claim 5, wherein the first vinyl copolymer and the second vinyl copolymer are selected from the group of ethylene acrylic acid copolymer, ethylene methacrylic acid copolymer, ethylene-vinyl acetate copolymer, and maleated polyolefin.

7. The composite structure of claim 1, wherein the first vinyl copolymer and the second vinyl copolymer have a different configuration of monomer-derived units.

8. The composite structure of claim 1, wherein the first vinyl copolymer and the second vinyl copolymer are formed with a different ratio of monomers.

9. The composite structure of claim 1, wherein the first vinyl copolymer and the second vinyl copolymer have a difference in melt flow index of from about 30 g/10 min to about 300 g/10 min, as measured in accordance with ASTM D-1238 at a copolymer temperature of 190° C. and with a load of 2.16 kg.

10. The composite structure of claim 1, wherein the weight ratio of the first vinyl copolymer to the second vinyl copolymer is from about 4:1 to about 1:4.

11. The composite structure of claim 1, wherein the first vinyl copolymer and the second vinyl copolymer are in a continuous phase, and wherein the primer layer further comprises a discontinuous phase.

12. The composite structure of claim 11, wherein the discontinuous phase is electrically conductive and the primer layer is electrically conductive.

13. The composite structure of claim 1, wherein the primer layer exhibits a resistance to solvent intrusion and polymer breakdown such that the composite structure passes a tape test for adhesion conducted in accordance with ASTM D3359-17.

14. The composite structure of claim 1, wherein the primer layer has a thickness of from about 0.5 microns to about 2.0 microns.

15. A battery component comprising:
a current collector;
a primer layer bonded to the current collector, the primer layer comprising:
a first vinyl copolymer formed from vinyl monomers having an acid function or derivative thereof, and
a second vinyl copolymer different from the first vinyl copolymer, wherein the second vinyl copolymer is formed from the same vinyl monomers as the first vinyl copolymer;
an active layer comprising an active material and a binder, bonded to the primer layer on an opposite side of the primer layer from the current collector; and
a battery solvent proximate to the active layer.

16. The battery component of claim 15, wherein the battery solvent is in direct contact with the primer layer.

17. The battery component of claim 15, wherein the first vinyl copolymer and the second vinyl copolymer are in a continuous phase, and wherein the primer layer further comprises a discontinuous phase.

18. The battery component of claim 17, wherein the discontinuous phase is electrically conductive and the primer layer is electrically conductive.

19. The battery component of claim 15, further comprising a fluorinated electrolyte dissolved in the battery solvent.

20. A method of manufacturing a composite structure, the method comprising the steps of:
forming a dry mixture comprising an active material and a binder;
forming a primer layer on a metal layer comprising an elemental metal and/or a metal alloy; and
adhering the dry mixture to the metal layer with the primer layer;
wherein the composite structure is manufactured in the absence of a drying step, wherein the primer layer comprises:
a first vinyl copolymer formed from vinyl monomers having an acid function or derivative thereof; and
a second vinyl copolymer different from the first vinyl copolymer, wherein the second vinyl copolymer is formed from the same vinyl monomers as the first vinyl copolymer.
